(19) United States
(12) Patent Application Publication
(10) Pub. No.: US 2019/0223524 A1
(43) Pub. Date: Jul. 25, 2019

(54) SUPPORT ACCESSORY FOR THE BACK OF THE HAND

(71) Applicant: Gonzalo Larrauri Puebla, Madrid (ES)

(72) Inventor: Gonzalo Larrauri Puebla, Madrid (ES)

(21) Appl. No.: 16/329,825

(22) PCT Filed: Sep. 2, 2016
(86) PCT No.: PCT/ES2016/070619

§ 371 Date: Mar. 1, 2019

(51) Int. Cl. A41D 13/01; G08B 5/00

(52) U.S. Cl. CPC A41D 13/01; A41D 13/08; G08B 5/004

(57) ABSTRACT

The glove signalling accessory is a contribution to the safety of people who do any activity at night or in dark environments. It allows any glove or hand to have a piece of reflective or backlit material adapted to it that does not interfere with the functionality of the glove and that adds visibility to a part of the human body, allowing indication or signalling by means of gestures, so that the material that is visible in the dark will increase the safety and the possibilities of non-verbal communication. The originality and functionality of the design of this accessory will make it possible to improve the safety of users of public roads at a very reasonable cost. It also allows participants in sports events to be identified by their hands and can be used as a support for advertising material.

### FIELD OF THE INVENTION

This invention relates to a signalling accessory that can be applied to gloves or directly on the bare hand, providing a means of signalling, reflection, advertising or even identification, forming a permanent part of the glove itself or an independent part of it.

The sector in which this invention is applied is that of safety accessories for road circulation and personal protective equipment of workers who carry out activities in dark environments or with a need for added visibility.

Likewise, the invention can be applied to the signalling and marking of competitors in sports events, in which the participants wear gloves and want to be identified or wear advertising on them.

### BACKGROUND OF THE INVENTION

In the numerous nocturnal activities or those take place in the dark, it is advisable to use reflective, fluorescent, or even backlit signalling garments. By way of example, garments of this kind are used in the following leisure activities: cycling, motorcycling, athletics, horse riding, skiing, etc., as well as by personnel of the state security forces, such as policemen, firemen, traffic wardens, and workers and professionals in general who perform activities in dark environments.

There are currently numerous garments and accessories that use different reflective or lighting technologies to enhance people's visibility, thereby improving their safety by allowing them to be seen by the reflection of the light or the light itself that these garments or devices generate. In this sense, we might mention reflective vests and harnesses, ankle-straps or wrist bands, covers for helmets, for backpacks, for boots, etc., which have these elements that improve personal signalling.

However, for the hands the only option currently available is gloves that include these reflective or backlit elements among their own components.

It should be noted that although the hands represent a small part of the body surface, because of their mobility and the possibility of gesturing with them, they are one of the parts of the body where the use of reflective or backlit material is very useful in order to be seen in the dark. For example, when riding bicycles and motorcycles, the hands are used to signal manoeuvres, so a reflective element worn on them is very useful to guarantee said signal being seen by others. The same applies to traffic wardens or mobility agents that control traffic by means of movements and gestures made with their hands. On the other hand, when running, the hands perform a very characteristic continuous movement which if made in the dark and carrying some reflective or backlit material in the dark would make it easier to be seen by others and thus ensure the runners' safety.

Furthermore, gloves are a perfect support to identify participants in trials or competitions or as advertising support, but there is currently no way to identify participants through their gloves, and the classic worn numbers are used for this.

### SUMMARY OF THE INVENTION

The device of the invention consists of an accessory that allows reflective, backlit, identifying or advertising material to be worn on gloves or directly on the hand, to make these a reflective element that improves visibility and therefore the safety of the people who perform any activity in the dark or to allow identification or advertising support by the participants in a sports event.

The support consists of a flat and flexible textile or plastic surface on which the reflective material, or material backlit by fixed or flashing light, the identification or advertising is supported by any fixed (sewing, adhesive, heat sealing or others), or removable (repositionable closures of a kind like Velcro, buckles, etc.) means.

This support piece will be of a shape and dimensions appropriate to the area of the hand on which it is intended to add the functionality of the reflective material.

In general, the approximate shape and dimensions consist of an essentially rectangular piece, about 5 centimetres wide by 15 centimetres long, which for a person of medium height with gloves of medium thickness would cover the area that runs between the wrist and the proximal interphalangeal joint.

In order to fasten the support to the user's glove, the support piece has bands of elastic textile material on its ends, adjustable in diameter by means of buckles, repositionable tape or other system to adjust the side closest to the arm by the larger diameter tape that fits around the wrist and on the other side by the band of a smaller diameter that fits to one, two or three adjacent fingers (excluding the thumb) at the height of the proximal phalanx.

In this way, the support piece is fixed on the back of the hand by the elastic bands that fix it to the wrist on one side and on the other side, as a two-finger ring, that fixes it to the first phalanges of the fingers, usually the ring and middle fingers, although it could also be adjusted to the index and middle fingers or even to the ring or little finger or a combination of three adjacent fingers in smaller hands.

The elasticity of the pieces that surround the wrist and phalanges and the flexibility of the support piece and its loose dimensions mean that the support, once installed, allows the hand's natural movement without hindering the extension or movements of the fingers that in some circumstances (riding bicycles or motorcycles) are necessary, for instance, to operate brake, clutch or accelerator levers).

The dimensions of the support piece and the adjustable elastic bands must be adapted to the size of the hands and the thickness of the gloves worn by the user, which may require some type of sizing or dimensioning to adapt to different circumstances.

The accessory will preferably be made using existing textile materials or with original manufacturing technology.

In any case, the production process will be a simple textile manufacture in which the support piece is cut or punched to the appropriate size and the adjustable elastic bands are sewn or heat sealed to it, with the special characteristic that this support piece, in the same production process or as a subsequent step, is added the reflective, marking or identification or fixed or intermittent backlit material that is to be applied by sewing, adhesive, heat sealing, or by repositionable means, that is to say, by means that allow the independence of the accessory as a whole with respect to the glove.

As for the elastic band fixing to the wrist, between the two pieces that participate in the device, different parallel alignments of transverse seam lines will be arranged to determine areas for the location of said elastic band, in order to be able to longitudinally adjust the positioning of this element, and so adapt to different needs.

Since two superimposed layers participate in the device, defining a cavity between them, said cavity could be accessible by practicable means of an opening defining a kind of pocket for small objects, such as keys, coins, documents, proximity cards such as the ski passes of the ski resorts used to open the stiles, etc.

Optionally, the device could carry digital screens or displays (LCD, OLED, electronic ink, etc.) with or without touch technology to allow people to view information, messages or images transmitted to the screen. These screens could work autonomously or be connected by wireless technology to other devices such as smart phones or watches or directly to data networks.

In short, it is an accessory that can be used as an advertising or identification element and on which, for example when it comes to embroidered badges or advertising stickers, these can be adapted to the support of the accessory and can therefore be viewed on the glove that uses the accessory itself.

### BRIEF DESCRIPTION OF THE DRAWINGS

To complement the description that is being made and for a better understanding of the characteristics of the invention, this descriptive report is accompanied, as an integral part of the same, by a set of plans where, for illustration and without limitation, the following has been set out:

FIG. 1 shows a representation corresponding to the two parts participating in the accessory of the invention, the support piece being seen with the elastic bands for adjustment and fastening as well as the piece of reflective material in position to be fixed to the support piece by any conventional means.

FIG. 2 shows a perspective of the practical application of the accessory on the external side of a glove, although it could also be arranged on the internal face of the same.

FIG. 3 shows a perspective of the practical application of the accessory arranged directly on the hand.

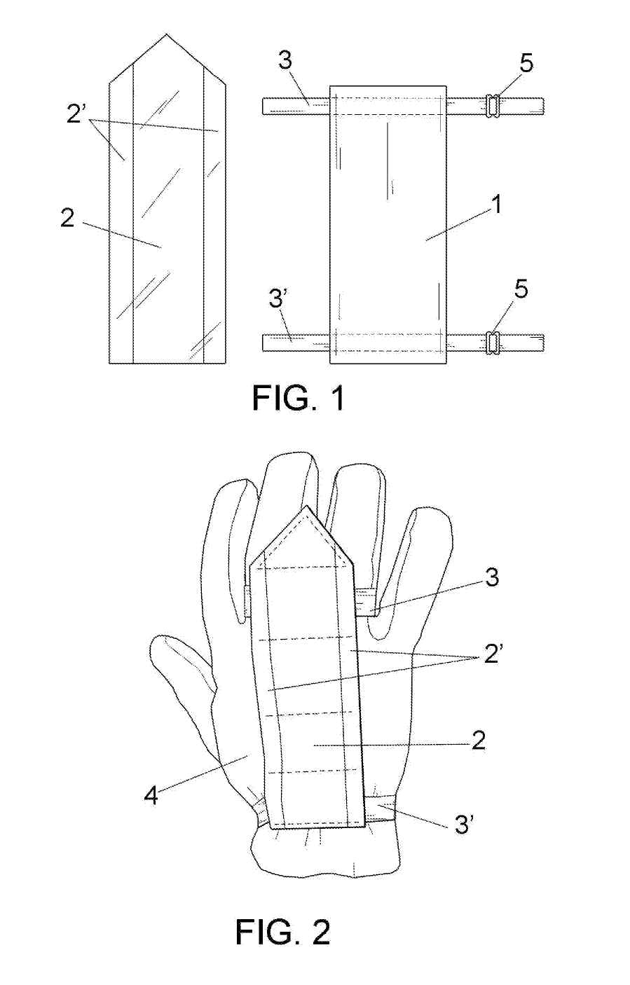

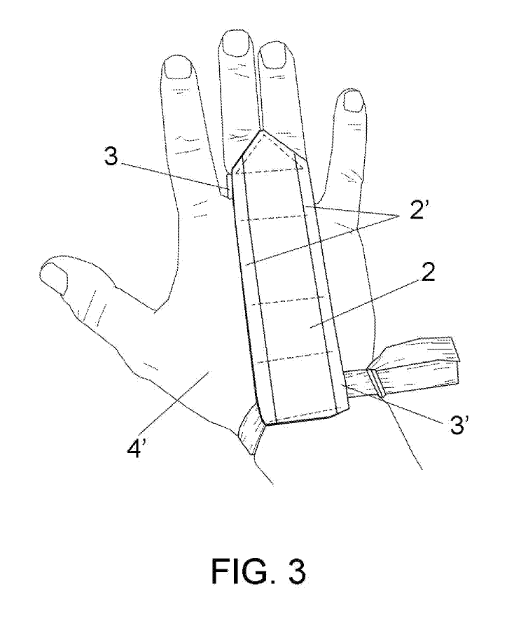

### DETAILED DESCRIPTION OF THE INVENTION

In view of the figures described, the accessory of the invention is built by the association of two pieces (1) and (2), the first of them preferably constituted by a textile material and with an essentially rectangular configuration, where the support piece (1) receives the fixture either by sewing, heat sealing or any other means, or even by means that allow the independence of the piece of reflective material (2) on the support (1), to form the accessory as a whole and in where the support piece (1) of a logically flexible nature as a textile, will be of a suitable size and configuration to cover the back of the hand between the fold of the wrist and the proximal interphalangeal joint, with elastic bands at its ends (3) and (3′), in the first case for attachment to one, two, or even three fingers of the glove (4) and therefore of the user, while the elastic band (3′) is intended for attachment to the wrist.

Both elastic bands (3) and (3′) will have means of adjustment (5), such as buckles or any other appropriate means, for adjustment to the contour of the fingers and that embraces the wrist to which it is fixed, while the piece of reflective material, which can be made of plastic, fabric or any other appropriate material, will have areas such as bands or characters that provide the reflective, backlit, identifying or advertising character, seeing, for example, in the figures how the reflecting piece (2) has two reflective side bands (2′).

1. (canceled)

2. (canceled)

3. (canceled)

4. (canceled)

5. (canceled)

6. (canceled)

7. (canceled)

8. A support accessory for the back of the hand comprising:
a first support piece having a distal end and a proximal end, wherein a first elastic band is provided at said distal end and a second elastic band provided at said proximal end;
and a second piece affixed to said first support piece, wherein said first support piece is configured to be secured to one of: a user's hand and a hand glove, so that said first elastic band is secured around at least one of finger of the user and the second elastic band is secured around a user's wrist.

9. The support accessory of claim 8, wherein said first support piece is made from a flexible material.

10. The support accessory of claim 8, wherein said first support piece is made from a textile material.

11. The support accessory of claim 8, wherein said second piece is made from a reflective material.

12. The support accessory of claim 8, wherein said second piece comprises identifying, advertising or backlit areas.

13. The support accessory of claim 8, wherein said second piece is removable from said first support piece.

14. The support accessory of claim 8, wherein said first support piece (1) has a length according to a length of a back side of said the user's hand or the hand glove.

15. The support accessory of claim 8, wherein said first support piece has a rectangular configuration.

16. The support accessory of claim 8, wherein adjustment means are provided to adjust the length of said first and second elastic bands.

17. The support accessory of claim 8, further comprising a display that allow the user to view information, messages or images.

18. The support accessory of claim 17, wherein the information, messages or images are transmitted to the display either autonomously or by a wireless connection to other devices or directly to data a network.

19. The support accessory of claim 8, further comprising a pocket between the first support piece and the second piece.

20. The support accessory of claim 8, wherein different transversal seam lines are provided on said first support piece to indicate the location of the second elastic band for attaching to the user wrist.
